(19) United States
(12) Patent Application Publication
(10) Pub. No.: US 2017/0009017 A1
(43) Pub. Date: Jan. 12, 2017

(54) POLYMIDE RESIN, THIN FILM THEREOF AND METHOD FOR MANUFACTURING THE SAME

(71) Applicant: Microcosm Technology CO, LTD., Tainan City (TW)

(72) Inventors: Tang-Chieh Huang, Tainan City (TW); Sih-Ci Jheng, Tainan City (TW)

(21) Appl. No.: 14/954,767

(22) Filed: Nov. 30, 2015

(30) Foreign Application Priority Data
Jul. 7, 2015 (TW) 104121999

(51) Int. Cl. C08G 73/10

(52) U.S. Cl. CPC C08G 73/1053; C08G 73/1046

(57) ABSTRACT

A polyimide resin derived from at least two dianhydrides and at least two diamines is provided. The dianhyride is selected from a group consisting of p-phenylenebis(trimellitate anhydride), 4,4′-(hexafluoroisopropylidene)-diphthalic anhydride, and 4,4′-(4,4′-isopropylidenediphenoxy)bis(phthalic anhydride). One of the diamine monomers is 2,2′-bis(trifluoromethyl)benzidine, and the other diamine monomers are selected from a group consisting of 2,2-bis[4-(4-aminophenoxy)phenyl, 1,3-bis(4-aminophenoxy)benzene, p-phenylenediamine, 4,4′-oxydianiline, 4,4′-methylenedianiline, 4,4′-diaminobenzanilide, 4,4′-diaminodiphenyl-sulfone, m-tolidine, 2,2-bis[4-(4-aminophenoxy)phenyl]hexafluoropropane and the combination thereof. The molar ratio of the dianhydrides to the diamines is between 0.85 and 1.15.

### BACKGROUND

Technical Field

The present invention is related to a polyimide resin, a thin film thereof and a method for manufacturing the same. The polyimide resin of the present invention having a low dissipation factor and a high coefficient of thermal expansion can be used to form an insulating layer for high frequency PCBs.

Description of Related Art

Flexible printed circuit board (FPCB) has been widely used in high-density portable electronic devices due to its flexible features. With the development of high-frequency wireless transmission and high-speed data transmission, more focus will be placed on high-frequency PCBs. One of the requirements for a high-frequency PCB is that the integrity of data/signals should remain unaffected during high-frequency transmission. The signal loss and/or interference will not occur during the transmission process.

Polyimide (PI) flexible copper clad laminate (FCCL) characterized by a good dimensional stability, a high heat resistance, a high coefficient of thermal expansion, an enhanced mechanical strength and a high resistance insulation has been widely used in the electronics industry. However, the high dielectric constant, high dissipation factor and some other characteristics of polyimide make it not suitable for high frequency PCBs. Currently, the common high-frequency PCB is made from liquid crystal polymer (LCP) and copper foil.

However, molecules of a film made of LCP tend to align in a parallel direction due to the unique molecular structure of LCP trends to align in parallel direction, resulting in poor mechanical properties in the cross-direction of an LCP film. The processing and application of LCP films are limited by such poor mechanical properties. The molecular structure of LCP also affects the glass transition temperature (Tg) and melting point (Tm) of an LCP film, which are very close. Thus it is not easy to control the dimensional stability of a FCCL with LCP film during thermocompression process.

### SUMMARY

In view of the above problems, the present invention provides a polyimide resin, a thin film thereof and a method for manufacturing the same. Polyimide resin of the present invention is characterized by a good dimensional stability, a high heat resistance, a high coefficient of thermal expansion, an enhanced mechanical strength and a good resistance insulation and a low dielectric dissipation factor. Thus polyimide resin of the present invention is suitable for high frequency PCBs.

According to one aspect of the present invention, a polyimide resin is provided. The polyimide resin is derived from the following composition:

(a) at least two dianhydride monomers selected from a group consisting of p-phenylenebis(trimellitate anhydride), 4,4′-(hexafluoroisopropylidene)-diphthalic anhydride, and 4,4′-(4,4′-isopropylidenediphenoxy)bis(phthalic anhydride); and

(b) at least two diamine monomers. One of the diamine monomers is 2,2′-bis(trifluoromethyl)benzidine with an amount of moles accounting for 70 to 90% of total moles of the diamine monomers. The other diamine monomers are selected from a group consisting of 2,2-bis[4-(4-aminophenoxy)phenyl, 1,3-bis(4-aminophenoxy)benzene, p-phenylenediamine, 4,4′-oxydianiline, 4,4′-methylenedianiline, 4,4′-diaminobenzanilide, 4,4′-diaminodiphenyl- sulfone, m-tolidine, 2,2-bis[4-(4-aminophenoxy)phenyl]hexafluoropropane, and the combination thereof.

The molar ratio of dianhydride monomers to diamine monomers is between 0.85 and 1.15, the dissipation factor of the polyimide resin is below 0.07, and the coefficient of thermal expansion of the polyimide is between 15 and 35 ppm/K.

According to another aspect of present invention, a method for manufacturing a polyimide resin is provided. The method comprises the following steps:

(a) dissolving at least two dianhydride monomers and at least two diamine monomers in a solvent. The dianhydride monomers are selected from a group consisting of p-phenylenebis(trimellitate anhydride), 4,4′-(hexafluoroisopropylidene)-diphthalic anhydride, and 4,4′-(4,4′-isopropylidenediphenoxy)bis(phthalic anhydride). One of the diamine monomers is 2,2′-bis(trifluoromethyl)benzidine, and the other diamine monomers are selected from a group consisting of 2,2-bis[4-(4-aminophenoxy)phenyl, 1,3-bis(4-aminophenoxy)benzene, p-phenylenediamine, 4,4′-oxydianiline, 4,4′-methylenedianiline, 4,4′-diaminobenzanilide, 4,4′-diaminodiphenyl- sulfone, m-tolidine, 2,2-bis[4-(4-aminophenoxy)phenyl]hexafluoropropane, and the combination thereof.

(b) mixing the dianhydride monomers and the diamine monomers, and inducing a polymerization reaction to form a polyamic acid. The molar ratio of dianhydride monomers to diamine monomers is between 0.85 and 1.15; and

(c) imidizing the polyamic acid to form the polyimide resin.

According to another aspect of the present invention, a polyimide resin manufactured with the foregoing method is provided.

According to another aspect of present invention, a thin film comprising the foregoing polyimide resin is provided.

Many of the attendant features and advantages of the present invention will be better understood with reference to the following detailed description considered in connection with the accompanying drawings.

### BRIEF DESCRIPTION OF THE DRAWINGS

FIG. 1A show an IR spectrum of polyimide resin according to Example 1; FIG. 1B shows a DSC(Differential scanning calorimetry) spectrum of polyimide resin according to Example 1.

FIG. 2A shows an IR spectrum of Polyimide resin according to Example 2; FIG. 2B shows a DSC(Differential scanning calorimetry) spectrum of polyimide resin according to Example 2.

FIG. 3A shows an IR spectrum of polyimide resin according to Example 3; FIG. 3B shows a DSC(Differential scanning calorimetry) spectrum of polyimide resin according to Example 3.

FIG. 4A shows an IR spectrum of polyimide resin according to Example 4; FIG. 4B shows a DSC(Differential scanning calorimetry) spectrum of polyimide resin according to Example 4.

FIG. 5A shows an IR spectrum of polyimide resin according to

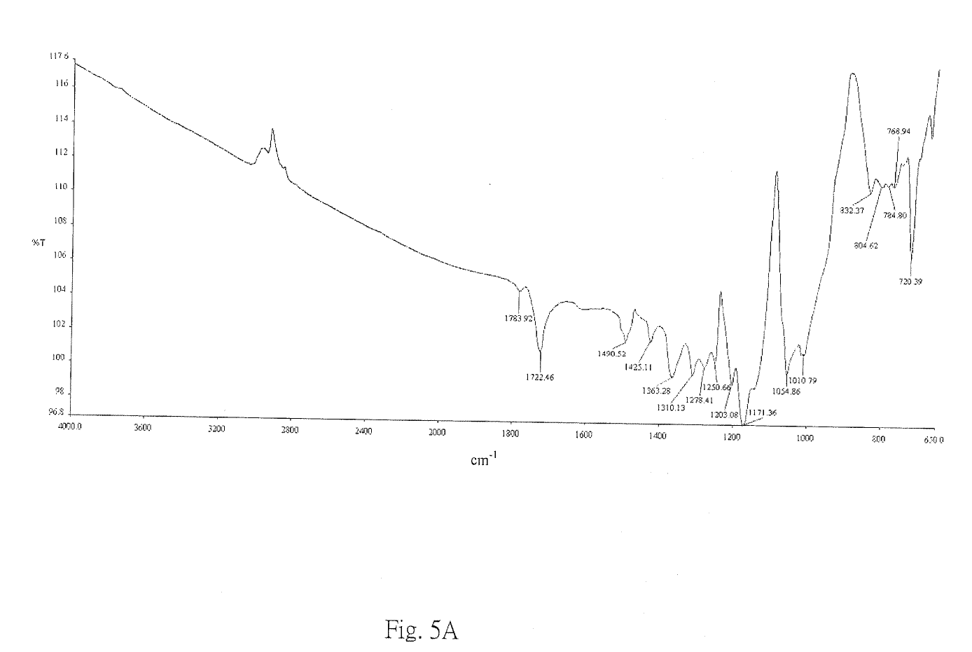

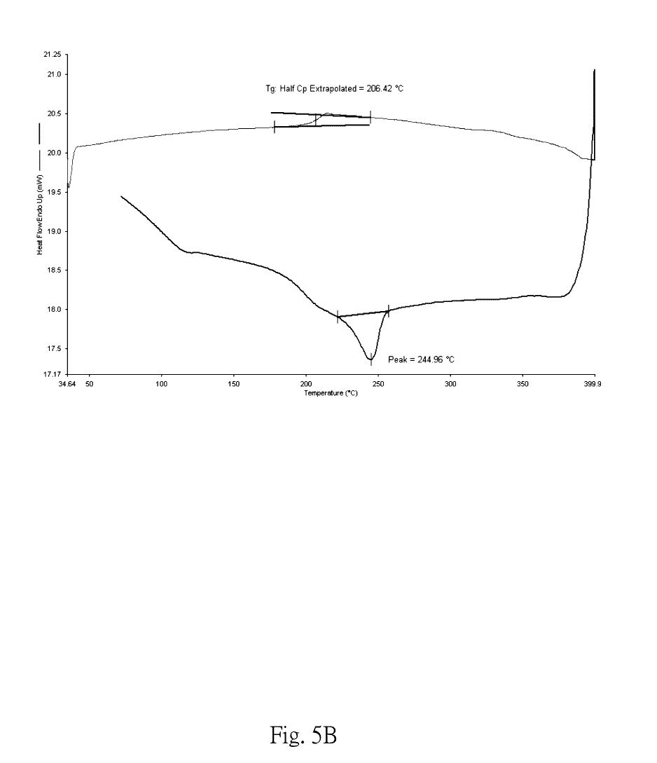

Example 5; FIG. 5B shows a DSC(Differential scanning calorimetry) spectrum of polyimide resin according to Example 5.

### DETAILED DESCRIPTION

The synthesis of the polyimide resin provided by the present invention was carried out in a polymerization reaction with dianhydride monomer and diamine monomer first. The polymerization reaction formed polyamic acid (the precursor of the polyimide resin). Next, the polyimide resin was produced by an imidization reaction of the polyamic acid.

The polymerization reaction could be carried out by dissolving dianhydride monomer and diamine monomer in a solvent, mixing the dissolved dianhydride monomer and the dissolved diamine monomer, and then obtaining polyamic acid (the precursor of the polyimide resin).

The solvent suitable for the present invention can be an aprotic solvent, such as N, N-dimethylacetamide, N, N-diethylacetamide, N, N-dimethylformamide or N-methyl-2-pyrrolidone, but is not limited thereto. Other suitable aprotic solvents can also be used in the polymerization reaction.

In one embodiment, the dianhydride monomers and the diamine monomers are in an amount of from 5 to 40 weight percent, based on a total weight of the dianhydride monomers, the diamine monomers and the solvent.

The imidization reaction (imidizing step) could be carried out in thermal condition. For example, heating the polyamic acid (the precursor of the polyimide resin) continuously or at intervals could trigger the imidization reaction. The polyimide resin thin film or insulating layer can be formed by coating the polyamic acid (the precursor of the polyimide resin) on a substrate, and then heating the whole substrate in an oven. Besides, the imidization reaction could be carried out with other known methods, and the present invention is not limited thereto.

The dianhydride monomer used for synthesizing the polyimide resin of the present invention is an aromatic dianhydride monomer. Preferably, the molecular weight of the dianhydride monomer is between 400 and 600. Aromatic dianhydride monomers with low molecular weights (about 200-350, such as PMDA, BPDA and BTDA) will increase the density of the polar aldimine group in the polyimide resin. The polyimide resin derived by aromatic dianhydride monomers with low molecular weights has a high dielectric constant.

The aromatic dianhydride monomer used in the present invention may comprise the following compounds:

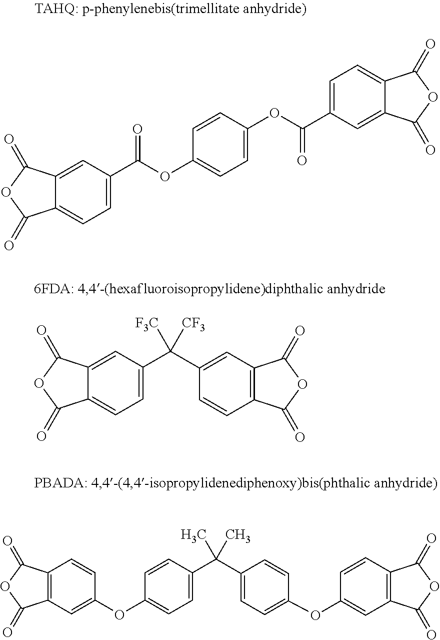 [SMILES: O=C(Oc1ccc(OC(=O)c2ccc3c(c2)C(=O)OC3=O)cc1)c1ccc2c(c1)C(=O)OC2=O ; O=C1OC(=O)c2cc(C(c3ccc4c(c3)C(=O)OC4=O)(C(F)(F)F)C(F)(F)F)ccc21 ; CC(C)(c1ccc(Oc2ccc3c(c2)C(=O)OC3=O)cc1)c1ccc(Oc2ccc3c(c2)C(=O)OC3=O)cc1]

The diamine monomer used for synthesizing the polyimide resin of the present invention is an aromatic diamine, which may comprise the following compounds:

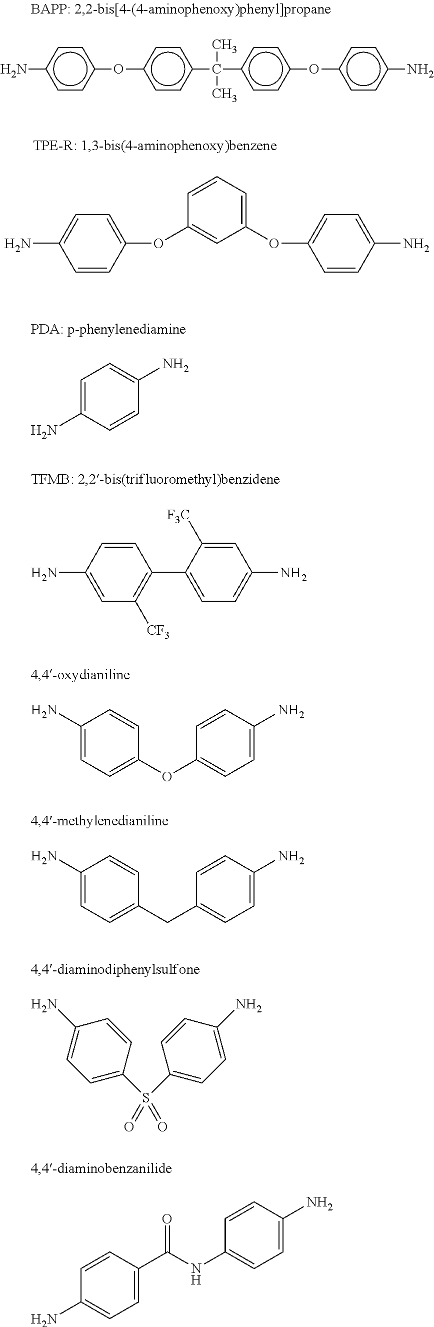

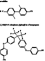 [SMILES: Cc1cc(N)ccc1-c1ccc(N)cc1C ; Nc1ccc(Oc2ccc(C(c3ccc(Oc4ccc(N)cc4)cc3)(C(F)(F)F)C(F)(F)F)cc2)cc1]

It is to be noted that the polyimide resin of the present invention is synthesized by two or more dianhydride monomers and two or more diamine monomers.

In the polyimide resin of the present invention, the molar ratio of dianhydride monomers to diamine monomers is between 0.85 and 1.15.

In one embodiment of the present invention, if the dianhydride monomer comprises p-phenylenebis(trimellitate anhydride), p-phenylenebis has an amount of moles accounting for 80 to 95% of total moles of the dianhydride monomers.

In one embodiment, if the dianhydride monomers comprise 4,4′-(hexafluoroisopropylidene)-diphthalic anhydride, 4,4′-(hexafluoroisopropylidene)-diphthalic anhydride has an amount of moles accounting for at most 15% of total moles of the dianhydride monomers.

In one embodiment, if the dianhydride monomers comprise 4,4′-(4,4′-isopropylidenediphenoxy)bis(phthalic anhydride), 4,4′-(4,4′-isopropylidenediphenoxy)bis(phthalic anhydride)has an amount of moles accounting for at most 15% of total moles of the dianhydride monomers.

In one embodiment, if the diamine monomers comprise 2,2′-bis(trifluoromethyl)benzidine, 2,2′-bis(trifluoromethyl)benzidine has an amount of moles accounting for 70 to 90% of total moles of the diamine monomers.

The polyimide resin described above is produced by mixing two or more dianhydride monomers and two or more diamine monomers at a specific ratio, and has a dielectric dissipation factor less than 0.007 and a coefficient of linear thermal expansion between 15 to 35 ppm/K.

Various examples will now be described to show the preparing methods of the polyamic acid (the precursor of the polyimide resin) of the present invention, and its physical or chemical property will be measured.

Preparation of the polyamic acid solution (the precursor of the polyimide resin)

### EXAMPLE 1

24.20 g (0.076 mole) of 2,2′-bis(trifluoromethyl)benzidine (TFMB), 1.85 g (0.017 mole) of p-phenylenediamine (PDA), 2.36 g (0.008 mole) of 1,3-bis(4-aminophenoxy)benzene (TPE-R) and 244.37 g of N-methyl-2-pyrrolidone (NMP) were added in a three-necked flask and stirred at 30° C. until completely dissolved. 41.75 g (0.091 mole) of p-phenylenebis(trimellitate anhydride) (TAHQ) and 2.83 g (0.005 mole) of 4,4′-(4,4′-isopropylidenediphenoxy)bis(phthalic anhydride) (PBADA) were then added and stirred at 25° C. for 24 hrs. The polymeration reaction was carried out to produce the polyamic acid solution of Example 1. In this example, the dianhydride and diamine monomers are in an amount of 23 weight percent of the total weight of the reaction solution [(24.20+1.85+2.36+41.75+2.83)/(24.20+1.85+2.36+41.75+2.83+244.37)×100%=23%].

### EXAMPLE 2

26.28 g (0.082 mole) of 2,2′-bis(trifluoromethyl)benzidine (TFMB), 3.74 g (0.009 mole) of 2,2-bis[4-(4-aminophenoxy)phenyl]propane (BAPP) and 215.78 g of N-methyl-2-pyrrolidone (NMP) were added in a three-necked flask and stirred at 30° C. until completely dissolved. 47.12 g (0.102 mole) of p-phenylenebis(trimellitate anhydride) (TAHQ) and 2.02 g (0.005 mole) of 4,4′-(hexafluoroisopropylidene)diphthalic anhydride (6FDA) were then added and stirred at 25° C. for 24 hrs. The polymeration reaction was carried out to produce the polyamic acid solution of Example 2. In this example, the dianhydride and diamine monomers are in an amount of 25 weight percent of the total weight of the reaction solution [(26.28+3.74+39.88+2.02)/(26.28+3.74+39.88+2.02+215.78)x100%=25%].

### EXAMPLE 3

29.13 g (0.091 mole) of 2,2′-bis(trifluoromethyl)benzidine (TFMB), 1.84 g (0.017 mole) of of p-phenylenediamine (PDA), 1.66 g (0.006 mole) of 1,3-bis(4-aminophenoxy)benzene (TPE-R) and 271.31 g of N-methyl-2-pyrrolidone (NMP) were added in a three-necked flask and stirred at 30° C. until completely dissolved. 39.88 g (0.087 mole) of p-phenylenebis(trimellitate anhydride) (TAHQ) and 5.92 g (0.011 mole) of 4,4′-(4,4′-isopropylidenediphenoxy)bis(phthalic anhydride) (PBADA) were then added and stirred at 25° C. for 24 hrs. The polymeration reaction was carried out to produce the polyamic acid solution of Example 3. In this example, the dianhydride and diamine monomers are in an amount of 24 weight percent of the total weight of the reaction solution [(29.13+1.84+1.66+47.12+5.92)/(29.13+1.84+1.66+47.12+5.92+271.31)×100%=24%].

### EXAMPLE 4

23.56 g (0.074 mole) of 2,2′-bis(trifluoromethyl)benzidine (TFMB), 1.49 g (0.014 mole) of p-phenylenediamine (PDA), 1.89 g (0.005 mole) of 2,2-bis[4-(4-aminophenoxy)phenyl]propane (BAPP) and 260.06 g of N-methyl-2-pyrrolidone (NMP) were added in a three-necked flask and stirred at 30° C. until completely dissolved. 38.10 g (0.083 mole) of p-phenylenebis(trimellitate anhydride) (TAHQ) and 4.09 g (0.009 mole) of 4,4′-(hexafluoroisopropylidene)diphthalic anhydride (6FDA) were then added and stirred at 25° C. for 24 hrs. The polymeration reaction was carried out to produce the polyamic acid solution of Example 4. In this example, the dianhydride and diamine monomers are in an amount of 21 weight percent of the total weight of the reaction solution [(23.56+1.49+1.89+38.10+4.09)/(23.56+1.49+1.89+38.10+4.09+260.06)×100%=21%].

### EXAMPLE 5

25.00 g (0.078 mole) of 2,2′-bis(trifluoromethyl)benzidine (TFMB), 1.49 g (0.014 mole) of p-phenylenediamine (PDA) and 244.32 g of N-methyl-2-pyrrolidone (NMP) were added in a three-necked flask and stirred at 30° C. until completely dissolved. 35.94 g (0.078 mole) of p-phenylenebis(trimellitate anhydride) (TAHQ), 4.08 g (0.009 mole) of 4,4′-(hexafluoroisopropylidene)diphthalic anhydride (6FDA) and 2.39 g (0.005 mole) of 4,4′-(4,4′-isopropylidenediphenoxy)bis(phthalic anhydride) (PBADA) were then added and stirred at 25° C. for 24 hrs. The polymeration reaction was carried out to produce the polyamic acid solution of Example 5. In this example, the dianhydride and diamine monomers are in an amount of 22 weight percent of the total weight of the reaction solution [(25.00+1.49+35.94+4.08+2.39)/(25.00+1.49+35.94+4.08+2.39+244.32)×100%=22%].

Comparative Examples 1-3 of the polyamic acid will be described in the following paragraphs. The Comparative Examples merely used one dianhydride monomer and one diamine monomer to produce the polyamic acid (the precursor of the polyimide resin). In contrast with the Comparative Examples, the polyamic acid of Examples 1-5 was produced by two or more dianhydride monomers and two or more diamine monomers.

### COMPARATIVE EXAMPLE 1

31.25 g (0.098 mole) of 2,2′-bis(trifluoromethyl)benzidine (TFMB) and 227.16 g of N-methyl-2-pyrrolidone (NMP) were added in a three-necked flask and stirred at 30° C. until completely dissolved. 44.47 g (0.097 mole) of p-phenylenebis(trimellitate anhydride) (TAHQ) was then added and stirred at 25° C. for 24 hrs. The polymeration reaction was carried out to produce the polyamic acid solution of Comparative Example 1. In this comparative example, the dianhydride and diamine monomers are in an amount of 25 weight percent of the total weight of the reaction solution [(31.25+44.47)/(31.25+44.47+227.16)×100%=25%].

### COMPARATIVE EXAMPLE 2

13.78 g (0.127 mole) of p-phenylenediamine (PDA) and 250.58 g of N-methyl-2-pyrrolidone (NMP) were added in a three-necked flask and stirred at 30° C. until completely dissolved. 56.90 g (0.124 mole) of p-phenylenebis(trimellitate anhydride) (TAHQ) was then added and stirred at 25° C. for 24 hrs. The polymeration reaction was carried out to produce the polyamic acid solution of Comparative Example 2. In this comparative example, the dianhydride and diamine monomers are in an amount of 22 weight percent of the total weight of the reaction solution [(13.78+56.90)/(13.78+56.90+250.58)×100%=22%].

### COMPARATIVE EXAMPLE 3

25.75 g (0.088 mole) of 1,3-bis(4-aminophenoxy)benzene (TPE-R) and 260.28 g of N-methyl-2-pyrrolidone (NMP) were added in a three-necked flask and stirred at 30° C. until completely dissolved. 39.33 g (0.085 mole) of p-phenylenebis(trimellitate anhydride) (TAHQ) was then added and stirred at 25° C. for 24 hrs. The polymeration reaction was carried out to produce the polyamic acid solution of Comparative Example 3. In this comparative example, the dianhydride and diamine monomers are in an amount of 20 weight percent of the total weight of the reaction solution [(25.74+39.33)/(25.74+39.33+260.28)×100%=20%].

### Property and Measurement of Polyimide Resin

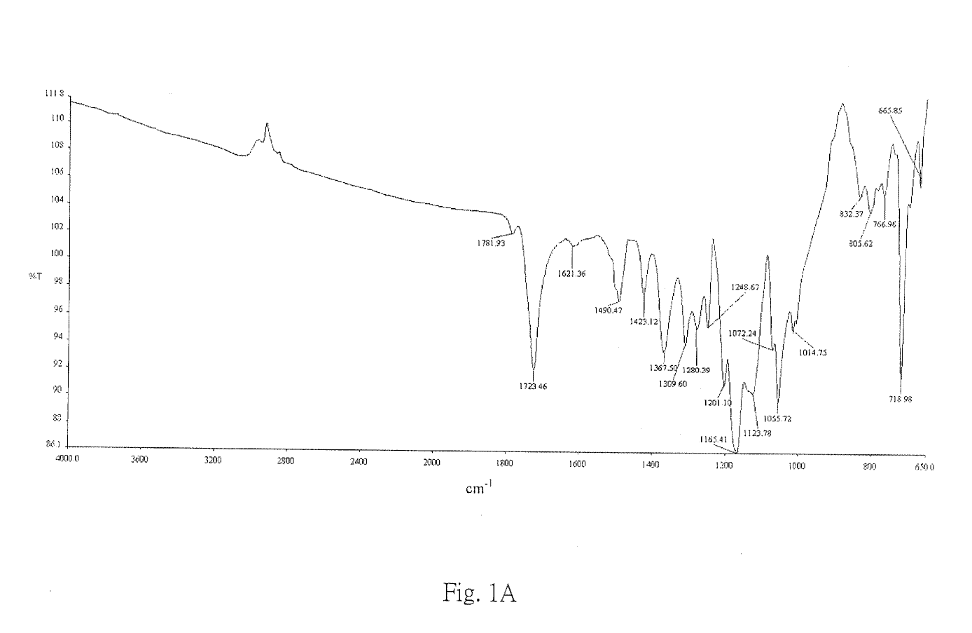

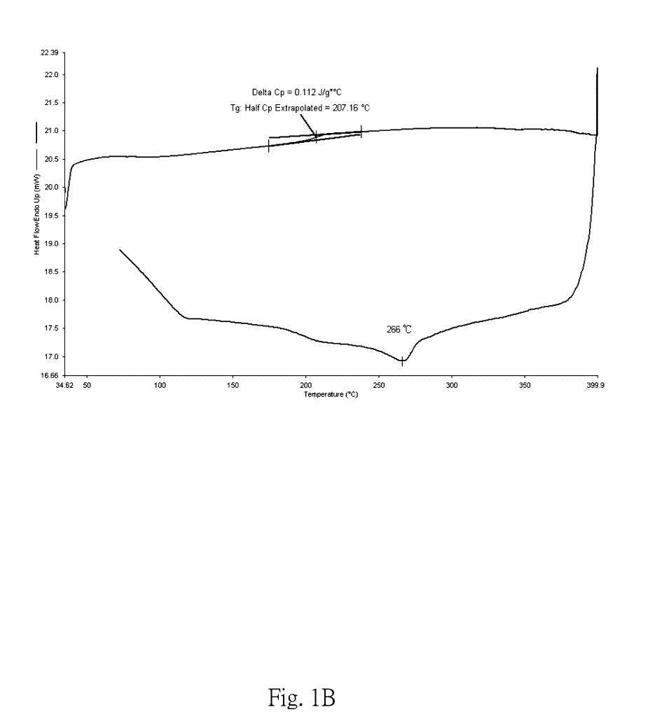

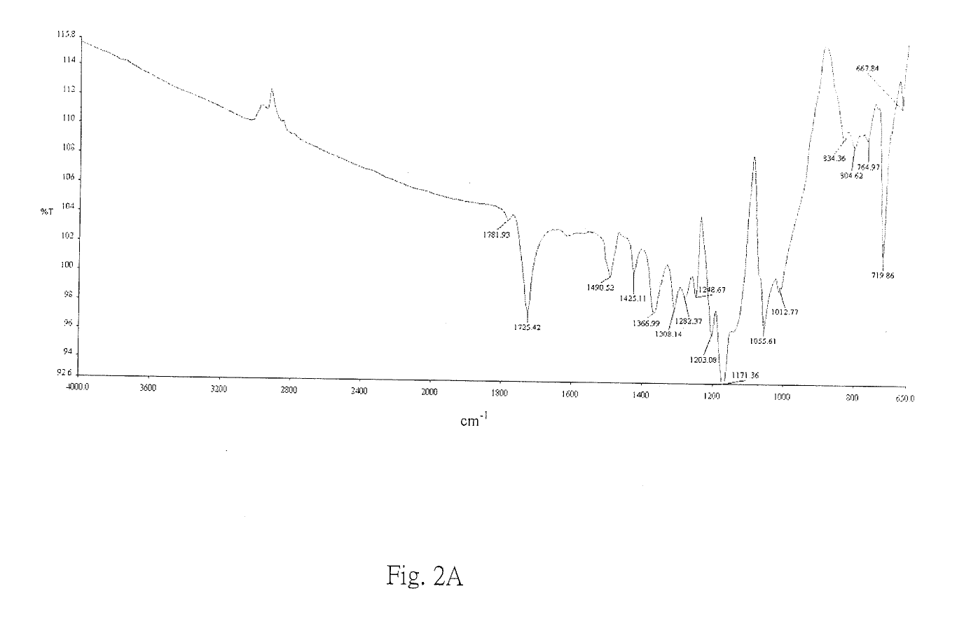

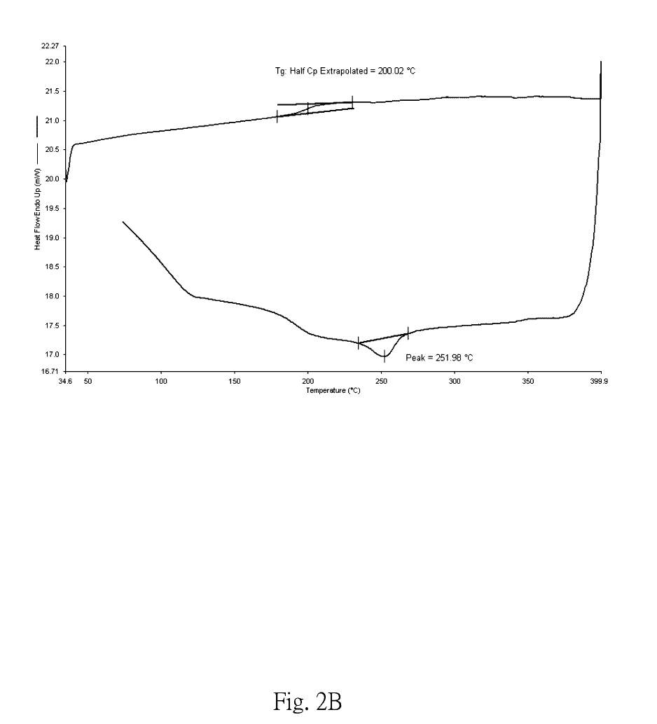

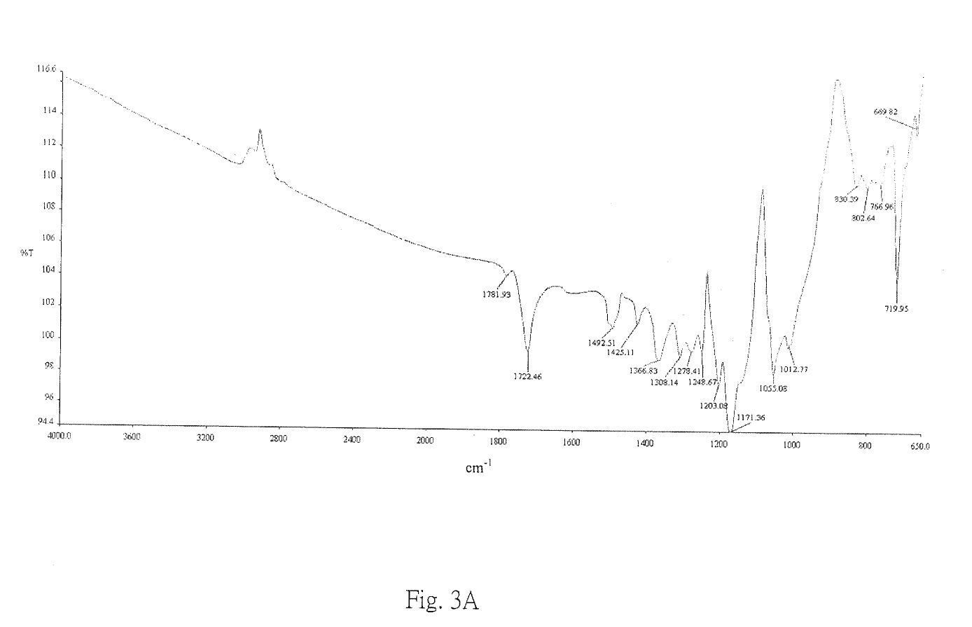

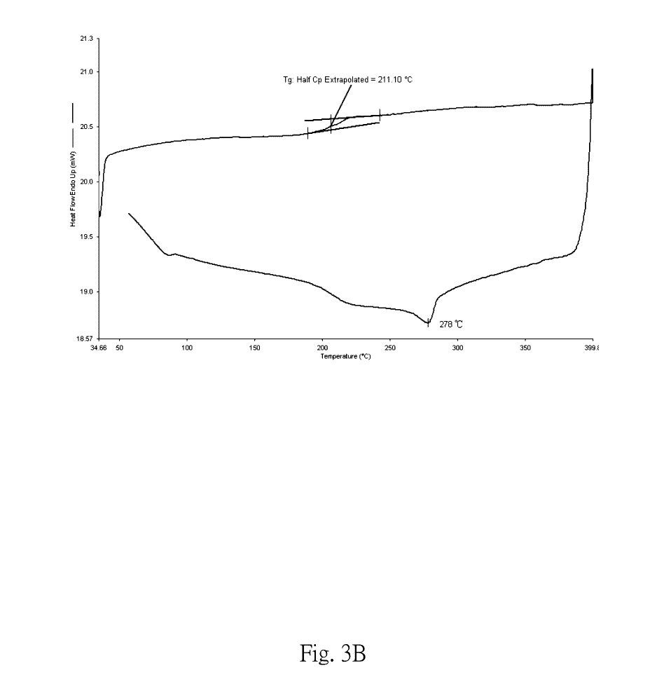

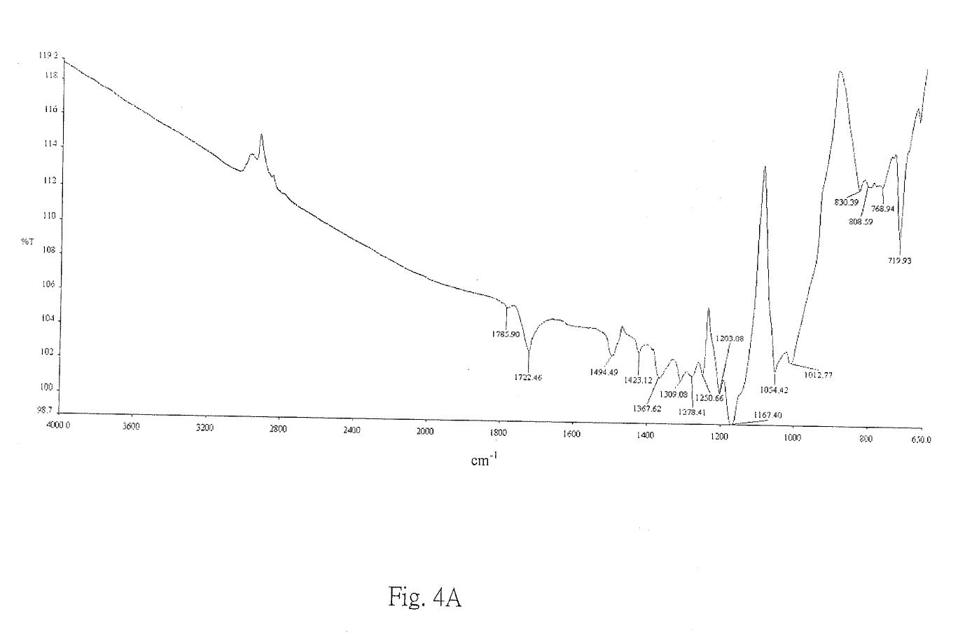

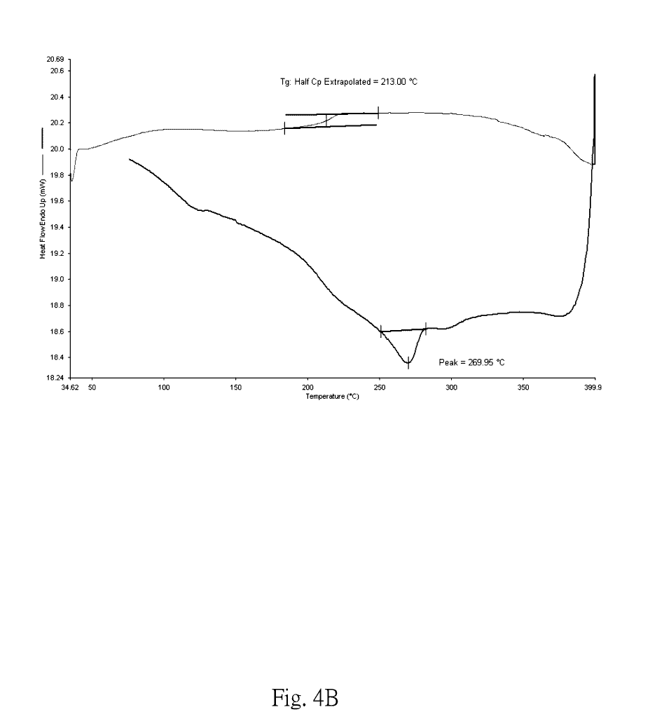

The compositions of respective polyimide films derived from the polyamic acid solutions of various Examples and Comparative Examples are listed in Table 1. Thin films were formed from the polyamic acid solutions (the precursor of the polyimide resin) of Examples and Comparative Example by the imidization reaction. The IR spectrum, dielectric constant (Dk), dissipation factor (Df), coefficient of linear thermal expansion (CTE), glass transition temperature (Tg) and crystallization temperature (Tc) of these thin film were measured. FIGS. 1A, 2A, 3A, 4A and 5A show the IR spectrums of the polyimide films of Example 1-5, respectively; FIGS. 1B, 2B, 3B, 4B and 5B show the DSC (Differential Scanning calorimeter) spectrums of polyimide films of

Example 1-5, respectively. The measured properties are listed in Table 2.

TABLE 1
Compositions of Polyimide Films

| | | | | | | | | Dianhydride + | Dianhydride + |
|---|---|---|---|---|---|---|---|---|---|
| | Dianhydride monomers | | | Diamine monomers | | | | Diamine | Diamine |
| | TAHQ | 6FDA | PBADA | TFMB | PDA | TPE-R | BAPP | monomer | monomer |
| | (mole) | (mole) | (mole) | (mole) | (mole) | (mole) | (mole) | (wt %) | (molar ratio) |
| Example 1 | 0.091 | | 0.005 | 0.076 | 0.017 | 0.008 | | 23 | 0.95 |
| Example 2 | 0.087 | 0.005 | | 0.082 | | | 0.009 | 25 | 1.01 |
| Example 3 | 0.102 | | 0.011 | 0.091 | 0.017 | 0.006 | | 24 | 0.99 |
| Example 4 | 0.083 | 0.009 | | 0.074 | 0.014 | | 0.005 | 21 | 0.99 |
| Example 5 | 0.078 | 0.009 | 0.005 | 0.078 | 0.014 | | | 22 | 1.00 |
| Comparative | 0.097 | | | 0.098 | | | | 25 | 0.99 |
| Example 1 | | | | | | | | | |
| Comparative | 0.124 | | | | 0.127 | | | 22 | 0.98 |
| Example 2 | | | | | | | | | |
| Comparative | 0.085 | | | | | 0.088 | | 20 | 0.97 |
| Example 3 | | | | | | | | | |

TABLE 2
Properties of Polyimide Films

| | Dk | Df | CTE | Tg | Tc |
|---|---|---|---|---|---|
| Example 1 | 3.18 | 0.005 | 27 | 207 | 266 |
| Example 2 | 3.08 | 0.004 | 29 | 200 | 252 |
| Example 3 | 3.14 | 0.005 | 31 | 211 | 278 |
| Example 4 | 3.11 | 0.005 | 32 | 213 | 270 |
| Example 5 | 3.20 | 0.006 | 28 | 206 | 245 |
| Comparative Example 1 | 3.17 | 0.011 | 28 | N/A | N/A |
| Comparative Example 2 | 3.30 | 0.015 | 15 | N/A | N/A |
| Comparative Example 3 | 3.09 | 0.007 | 56 | 233 | N/A |

Properties in Table 2 were measured from polyimide films derived from polyamic acid solutions. The methods of measurement are described as follows:

### Dielectric Constant (Dk):

This property is measured by RF Impedance/Material Analyzer (Agilent HP4291) at 10 GHz with IPC-TM-650-2.5.5.9 test method.

Dissipation factor (Df):

This property is measured by RF Impedance/Material Analyzer (Agilent HP4291) at 10 GHz with IPC-TM-650-2.5.5.9 test method.

### Coefficient of (Linear) Thermal Expansion (CTE):

This property is measured by thermal mechanical analysis. The thin film is extended under condition of weight 3 g/thickness 20μ and heating rate 10° C./min, and the CTE is the average of values calculated from 50 to 200° C. The material with a low CTE is hard to deform during the PCB baking process, so that the production system has a high yield rate.

### Glass Transition Temperature (Tg) and Crystallization Temperature (Tc):

This property is measured by Differential Scanning calorimeter (SII Nano Technology DSC-6220). The polyimide resin underwent the following steps in N₂ atmosphere heating at 10° C./min and then cooling at 30° C./min; and heating again at rate of 10° C./min. Glass transition temperature was determined by the value measured in the first or second heating process. Crystallization temperature was determined by the exothermic peak value measured in first cooling process.

The requirement for a high-frequency circuit are the transmission speed and the signal quality. Electrical properties such as dielectric constant (Dk) and dissipation factor (Df) are main factors that affect these criteria. The reason could be explained by the following formula:

α_{d}=0.9106×\sqrt{ε_{R}}×F_{GHz}×tan δ
wherein α_{d}: transmission loss
ε_{R}: dielectric constant (Dk)
F_{GHz}: frequency
tan δ: dissipation factor (Df)

The above formula shows that the Df is more relative to transmission loss than Dk: the lower the Df, the lower the transmission loss. Thus, the material with a lower Df is more suitable for high frequency PCBs.

Table 1 and Table 2 show that the dissipation factors (Df) and coefficients of thermal expansion (CTE) of Examples 1-5 of the present invention (use of two or more dianhydride and two or more diamine monomers) are lower than those of Comparative Examples (use of only one dianhydride and one diamine monomer). The reason is that the aromatic ester functional group of single dianhydride monomer (such as TAHQ) and the aldimine functional group form a huge plane resonance structure. The huge plane structure affects the arrangement of the polyamic acid solution (the precursor of the polyimide resin) and polyimide resin. Thus the polyimide resin derived from single dianhydride and diamine monomer has a random arrangement and a low crystallinity. In addition to TAHQ which serves as a main dianhydride monomer, another dianhydride monomer with a molecular weight between 400 to 600 is introduced to the polyimide resin of the present Examples. Introducing another dianhydride monomer to the polyimide resin not only helps maintain the amount of aldimine group to prevent the dielectric constant from increasing but also enhances the arrangement of aromatic polyester group to improve the crystallinity. Referring to the experimental results in Table 2, the polyimide films of Comparative Example 1-3 (without the use of additional dianhydride monomers such as 6FDA and PBADA) are non-crystalline transparent films. In contrast with Comparative Example 1-3, the polyimide films of Examples 1-5 (use of 6FDA and/or PBADA) are translucent films, and their Tg and Tc are different from those of Comparative Examples.

Besides, the Comparative Examples show how different diamine monomers would affect properties of the polyimide resin. Comparative Example 1 has a CTE similar to those of Examples, and has a higher Df than Examples. Comparative Example 2 (PDA diamine monomer) has a lower CTE but a higher Df than other Comparative Examples. Comparative Example 3 (TPE-R diamine monomer) has a lower Df than other Comparative Examples, but its Df is still higher than those of Examples 1-5. The reason is that the non-linear diamine monomer (such as TPE-R, BAPP) has a lower rotation barrier, lower Df changes but a higher CTE. In contrast, the linear diamine monomer (such as PDA, TFMB) has a higher Df but a lower CTE. The polyimide resin of the present invention mixes two or more diamine monomers (for example the linear and non-linear diamine monomers) to attain a balance between a low CTE and a low Df, thereby obtaining a polyimide resin suitable for high frequency PCBs.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A polyimide resin derived from the following composition:
(a) at least two dianhydride monomers selected from a group consisting of p-phenylenebis (trimellitate anhydride), 4,4′-(hexafluoroisopropylidene)- diphthalic anhydride, 4,4′-(4,4′-isopropylidenediphenoxy)bis(phthalic anhydride) and the combination thereof; and
(b) at least two diamine monomers, wherein one of the diamine monomers is 2,2′-bis(trifluoromethyl)benzidine with an amount of moles accounting for 70 to 90% of total moles of the diamine monomers; the other diamine monomers are selected from a group consisting of 2,2-bis[4-(4-aminophenoxy)phenyl, 1,3-bis(4-aminophenoxy)benzene, p-phenylenediamine, 4,4′-oxydianiline, 4,4′-methylenedianiline, 4,4′-diaminobenzanilide, 4,4′-diaminodiphenyl- sulfone, m-tolidine, 2,2-bis[4-(4-aminophenoxy)phenyl]hexafluoropropane and the combination thereof and has an amount of moles accounting for 10 to 30% of total moles of the diamine monomers;
wherein a molar ratio of the dianhydride monomers to the diamine monomers is between 0.85 and 1.15, a dissipation factor of the polyimide resin is below 0.07, and a coefficient of thermal expansion of the polyimide is between 15 and 35 ppm/K.

2. The polyimide resin of claim 1, wherein the dianhydride monomers comprise p-phenylenebis(trimellitate anhydride) having an amount of moles accounting for 80 to 95% of total moles of the dianhydride monomers.

3. The polyimide resin of claim 1, wherein the dianhydride monomers comprise 4,4′-(hexafluoroisopropylidene)-diphthalic anhydride having an amount of moles accounting for at most 15% of total moles of the dianhydride monomers.

4. The polyimide resin of claim 1, wherein the dianhydride monomers comprise 4,4′-(4,4′-isopropylidenediphenoxy)bis(phthalic anhydride) having an amount of moles accounting for at most 15% of total moles of the dianhydride monomers.

5. The polyimide resin of claim 1, wherein a structure of the other diamine monomers is non-linear.

6. A method for manufacturing a polyimide resin, comprises the following steps:
(a) dissolving at least two dianhydride monomers and at least two diamine monomers in a solvent, wherein the dianhydride monomers are selected from a group consisting of p-phenylenebis(trimellitate anhydride), 4,4′-(hexafluoroisopropylidene)-diphthalic anhydride, 4,4′-(4,4′-isopropylidenediphenoxy)bis(phthalic anhydride) and the combination thereof; one of the diamine monomers is 2,2′-bis(trifluoromethyl)benzidine, and the other diamine monomers are selected from a group consisting of 2,2-bis[4-(4-aminophenoxy)phenyl, 1,3 -bis (4-aminophenoxy)benzene, p-phenylenediamine, 4,4′-oxydianiline, 4,4′-methylenedianiline, 4,4′-diaminobenzanilide, 4,4′-diaminodiphenyl- sulfone, m-tolidine, 2,2-bis[4-(4-aminophenoxy)phenyl]hexafluoropropane and the combination thereof;
(b) mixing the dianhydride monomers and the diamine monomers, and inducing a polymerization reaction to form a polyamic acid, wherein a molar ratio of the dianhydride monomers to the diamine monomers is between 0.85 and 1.15; and
(c) imidizing the polyamic acid to form the polyimide resin.

7. The method of claim 6, wherein 2,2′-bis(trifluoromethyl)benzidine has an amount of moles accounting for 70 to 90% of total moles of the diamine monomers.

8. The method of claim 6, wherein the solvent is an aprotic solvent.

9. The method of claim 8, wherein the solvent is selected from a group consisting of N,N-dimethylacetamid, N,N-diethylacetamid, N,N-dimethylformamide and N-methyl-2-pyrrolidone.

10. The method of claim 6, wherein the dianhydride monomers and the diamine monomers are in an amount of from 5 to 40 weight percent, based on a total weight of the dianhydride monomers, the diamine monomers and the solvent.

11. A polyimide resin made from the method of claim 6, wherein the dissipation factor of the polyimide resin is below 0.07, and the coefficient of thermal expansion of the polyimide resin is between 15 and 35 ppm/K.

12. A thin film comprises a polyimide resin of claim 1.
